(19) United States
(12) Patent Application Publication
(10) Pub. No.: US 2020/0108475 A1
(43) Pub. Date: Apr. 9, 2020

(54) Press-in connecting element and method for anchoring press-in connecting elements in a permanently deformable flat metal material or components or workpieces produced therefrom

(71) Applicant: Heiko Schmidt, Lappersdorf (DE)

(72) Inventor: Heiko Schmidt, Lappersdorf (DE)

(21) Appl. No.: 16/605,282

(22) PCT Filed: Feb. 7, 2018
(86) PCT No.: PCT/EP2018/052991

§ 371 Date: Oct. 15, 2019

(30) Foreign Application Priority Data
Apr. 24, 2017 (DE) 10 2017 108 639.0

(51) Int. Cl. B23P 19/06; F16B 37/06

(52) U.S. Cl. CPC B23P 19/064; F16B 37/068

(57) ABSTRACT

The invention relates to a press-in connecting element for inserting into a permanently deformable flat metal material or a component or workpiece produced therefrom, by joining and pressing. The press-in element includes a head section and a shaft section, which adjoins the head section along a longitudinal axis (LA) and which is set back relative to the head section. The shaft section is made up of at least a joining section, which directly adjoins the head section and which has a lateral surface having knurling (RA), and a press-in section, which adjoins the joining section along the longitudinal axis (LA). Especially advantageously, the knurled joining section has a first diameter (d1) and the press-in section has a second diameter (d2) and the second diameter (d2) is less than the first diameter (d1), the second diameter (d2) corresponding approximately to the initial diameter (D) of the joining section before the knurling (RA) is formed in the lateral surface or approximately to the first diameter (d1) minus half of the knurling depth (T).

### BACKGROUND OF THE INVENTION

The invention relates to a press-in connecting element and a method for anchoring press-in connecting elements in a permanently deformable flat metal material or components or workpieces produced therefrom.

Press-in connecting elements which are inserted or anchored in a permanently deformable flat metal material, in particular a metal sheet or a component or workpiece produced therefrom, by joining and subsequent pressing, are well-known.

Such press-in connecting elements are often designed in the form of press-in nuts with an internal thread or press-in sleeves without an internal thread. As a result of the corresponding choice of material hardness of the material of the press-in connecting element in comparison to the permanently deformable flat metal material, only the flat metal material, in particular metal sheet, and not the press-in connecting element, is deformed per se during the press-in process.

Press-in connecting elements generally have a sleeve-like main body having a head section and a shaft section, which adjoins the head section along a longitudinal axis and is cross-section reduced in comparison to the head section. The shaft section comprises a joining section, which directly adjoins the head section, the lateral surface of which is designed as a knurl or other non-round or polygonal lateral surface for fixing the press-in connecting element in the metal sheet in a rotationally fixed manner. A preferably annular press-in section is provided on the free end of the shaft section opposite the head section, which press-in section forms an undercut between the joining section and the press-in section.

After joining, i.e. after inserting the joining section of the shaft section of the press-in connecting element into a joining opening prepared in the metal sheet, also called pre-punching, the connecting or anchoring of the connecting element takes place through pressing by plastically deforming the metal sheet in the region of the joining opening, in which metal sheet the press-in connecting element is to be anchored. For the connection produced between the sheet and the connecting element by joining and pressing, it is required, inter alia, that this connection has a high resistance to pressing out of the press-in connecting element from the metal sheet through axially acting forces as well as a high resistance to twisting, i.e. a sufficiently high torque absorption. This is achieved, inter alia, by the material of the metal sheet flowing during pressing into the undercut between the joining section and the press-in section. Joining and pressing of the press-in connecting elements often takes place using a so-called punching head in a tool, by way of example a follow-on tool, in which the respective workpiece or component is also produced from the metal sheet, e.g. by punching and/or bending.

When inserting and joining the press-in connecting element into the metal sheet or into the pre-punching in the metal sheet, as a result of an unfavorable size of the joining section and/or of the press-in section of the shaft section in relation to the pre-punching in the metal sheet, an undesirable material displacement of the metal sheet in the axial direction and possibly into the undercut section may disadvantageously occur, which can have a negative impact on the subsequent punching process, and can in particular lead to an incorrect positioning and/or fixing of the connecting element.

### SUMMARY OF THE INVENTION

On that basis, it is the object of the invention to provide a press-in connecting element and a method for anchoring same in a permanently deformable flat metal material or component or workpiece produced therefrom, wherein an undesired material displacement in the axial direction when joining the press-in connecting element can be avoided.

An essential aspect of the press-in connecting element according to the invention can be seen in that the knurled joining section has a first diameter and the press-in section has a second diameter and the second diameter is smaller than the first diameter, the second diameter corresponding approximately to the initial diameter of the joining section before the knurl is formed in the lateral surface or approximately to the first diameter minus half of the knurl depth. Therefore, the diameter of the knurl or joining section of the shaft section in comparison to the punching section of the shaft section of the press-in connecting element is designed particularly advantageously in such a manner that there is no material displacement in the axial direction either through the punching section or through the knurl or joining section when inserting the press-in connecting element into a sheet element. Advantageously, the punching process is therefore not negatively influenced. The material displacement is almost exclusively produced by the punching tool or a die with annular embossing collar.

In a preferred embodiment, the knurl is formed as a so-called RAA knurl having a plurality of grooves running parallel to the longitudinal axis. Such RAA knurls form a serrated profile oriented in the longitudinal direction of the connecting element and thus also in the joining direction of the connecting element, such that a material displacement into the grooves of the knurl which are inserted between two serrations is possible when joining. Furthermore advantageously, an axial material displacement is effectively prevented by aid of the dimensioning according to the invention of the diameters of the joining and press-in section of the press-in connecting element by virtue of the orientation of the grooves parallel to the longitudinal axis.

Particularly preferably, the knurl formed as an RAA knurl has a spacing and a profile angle and the difference between the first and second diameter is according to the invention dependent on the spacing of the knurl, wherein the following relationship exists between the first and second diameter d1, d2 and the spacing t:

d1−0.5*t=d2

The RAA knurl is standardized in DIN82 and may by way of example have standardized spacings of 0.5 mm, 0.6 mm, 0.8 mm, 1.0 mm, 1.2 mm or 1.6 mm. By way of example, a spacing t of 0.8 mm and a profile angle of 90° is particularly preferable.

Particularly advantageously, in the case of the press-in connecting element according to the invention, the first diameter is selected such that it corresponds to the diameter of a virtual circumference around the longitudinal axis, on which the outer tips of the knurl come to rest.

According to the invention, the knurl depth corresponds to the difference of the radius of the virtual circumference around the longitudinal axis, on which the outer tips of the knurl or the serrations of the serrated profile come to rest, and the radius of the further virtual circumference around the longitudinal axis, on which the inner tips of the knurl or the serrations of the serrated profile come to rest.

Further advantageously, an annular undercut section is formed between the knurled joining section and the press-in section, which undercut section preferably forms a recess which is groove-shaped and/or annular by way of example and extends concentrically to the longitudinal axis, in which recess the material of the metal sheet surrounding the press-in connecting element is plastically deformed when pressing the press-in connecting element with the metal sheet. As a result of the “filling” of the annular undercut section with material of the metal sheet caused hereby, the press-in connecting element is additionally anchored in the metal sheet alongside the knurl of the joining section and is secured in particular against twisting.

Particularly preferably, the annular undercut section has a third diameter which is smaller than the second diameter and, to be specific, the difference between the second and third diameter is preferably between 0.25 times and one times the spacing of the knurl formed as an RAA knurl. With the mentioned dimensioning of the annular undercut section in relation to the diameters of the joining and press-in section, an optimal anchoring of the press-in connecting element in the metal region could be achieved with a good joining performance. The press-in section is preferably formed by an annular press-in collar, via which a self-punching function can also be provided.

A prefabricated assembly comprising a press-in connecting element according to the invention and a permanently deformable flat metal material or a component or workpiece produced therefrom is likewise the object of the invention, wherein the press-in connecting element is inserted into the permanently deformable flat metal material or a component or workpiece produced therefrom, by joining and pressing, or is anchored therein.

A further object of the invention is a method for anchoring a press-in connecting element in a permanently deformable flat metal material, in particular a metal sheet or a component or workpiece produced therefrom, by joining and pressing. The press-in connecting element has a head section and a shaft section, which adjoins the head section along a longitudinal axis and which is set back relative to the head section. The shaft section comprises at least a joining section, which directly adjoins the head section, with a lateral surface having a knurl and a press-in section, which adjoins the joining section along the longitudinal axis. Particularly advantageously, when joining the press-in connecting element into the permanently deformable flat metal material, in particular metal sheet, the press-in connecting element is inserted, without material displacement of the flat material or metal sheet along the longitudinal axis or in the joining direction, into the permanently deformable flat metal material, in particular metal sheet, preferably a joining opening or pre-punching provided therein. Thus, when joining the press-in connecting element into the flat material or metal sheet, the material of the flat material or metal sheet surrounding the press-in connecting element is displaced exclusively radially with respect to the longitudinal axis or joining direction. As a result, the subsequent press-in process is less prone to error and thus more reliably practicable.

Further advantageously, after being joined into the permanently deformable flat metal material, in particular metal sheet, the inserted press-in connecting element is pressed with the flat material or metal sheet in such a manner that the material of the flat material or metal sheet surrounding the press-in connecting element is plastically deformed and is displaced into an annular undercut section provided between the knurled joining section and the press-in section. Owing to the dimensioning according to the invention of the joining and press-in sections of the press-in connecting element, a uniform plastic deformation of the material of the flat material or metal sheet surrounding the press-in connecting element into the annular undercut section is possible.

In a preferred embodiment, during pressing, a die interacting with a support and having an embossing collar is used, which receives the press-in section in such a manner that a flow of the material of the flat material or metal sheet is brought about without deforming the press-in connecting element for the anchoring or pressing of the press-in connecting element in the flat material or metal sheet.

The expressions “approximately”, “substantially” or “somewhat” signify, in the context of the invention, deviations from the respective exact value of +/−10%, preferably of +/−5% and/or deviations in the form of changes which are insignificant for the function.

Further developments, advantages and possible applications of the invention will also become apparent from the following description of exemplary embodiments and from the figures. In this respect, all features described and/or depicted are, in their own right or in any combination, in principle the object of the invention, irrespective of their summary in the claims or their back-reference. The contents of the claims are also incorporated in the description.

### BRIEF DESCRIPTION OF THE DRAWINGS

The invention is outlined in more detail hereinafter based on the figures of exemplary embodiments, in which:

FIG. 1 shows a perspective view of a press-in connecting element according to the invention;

FIG. 2 shows an end-side view of the shaft section of the press-in connecting element according to the invention in accordance with FIG. 1;

FIG. 3 shows a longitudinal section along the line A-A through the press-in connecting element in accordance with FIG. 2;

FIG. 4 shows a schematic longitudinal section through an alternative embodiment of a press-in connecting element; and

FIG. 5 shows a schematic longitudinal section through a press-in connecting element according to the invention which is inserted into a metal sheet and pressed therewith, as well as the associated tools.

### DETAILED DESCRIPTION OF THE INVENTION

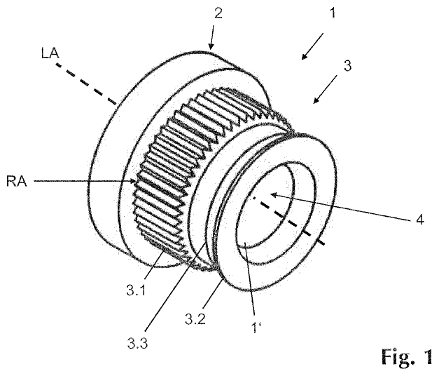

FIG. 1 shows, by way of example, a perspective representation of a press-in connecting element 1 according to the invention, which is designed as a press-in nut element with internal thread in the embodiment shown. Alternatively, however, the press-in connecting element 1 according to the invention can also be produced as a press-in sleeve member without internal thread. The press-in connecting element 1 is made in one piece or integrally formed and is produced from a material or material mixture.

The press-in connecting element 1 is designed for inserting and anchoring into a permanently deformable flat metal material, in particular a metal sheet 10 or a component or workpiece produced therefrom, by joining and pressing, and for this purpose comprises a sleeve-like main body extending along a longitudinal axis LA, which main body comprises at least a head section 2 and a shaft section 3, which directly adjoins the head section along the longitudinal axis LA. The shaft section 3 is formed by a substantially circular-cylindrical collar, which has a reduced cross-section in comparison to the head section 2, such that the head section 2 comes to abut against the upper side of the metal plate in the inserted state. The head section 2 is also preferably produced in the form of a circular-cylindrical body section.

The sleeve-like main body further comprises a preferably circular-cylindrical cavity 4, which is enclosed by an inner wall 1′ of the press-in connecting element 1 extending concentrically toward the longitudinal axis LA and extends over the entire length of the press-in connecting element 1. In the embodiment illustrated in the figures as a press-in nut element or press-in nut, the inner wall 1′ is provided, by way of example, with an internal thread. The circular-cylindrical cavity 4 extends in this case over the entire length of the press-in connecting element 1 and thus forms a through bore for receiving and/or passing through a rod-shaped element, by way of example the shaft of a screw or bolt.

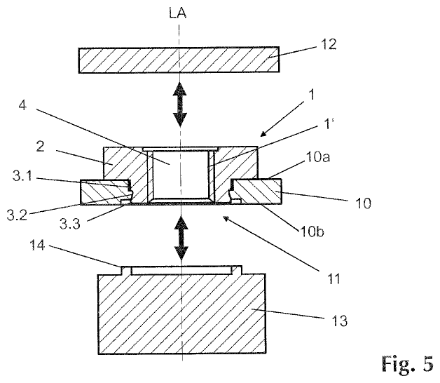

The press-in connecting element 1 is formed for pressing into a metal sheet 10 or into a component or workpiece produced from a metal sheet 10, and it should be anchored therein by joining and pressing preferably with a high press-out force and torque absorption. FIG. 5 shows, by way of example, a schematic longitudinal section through a press-in connecting element 1 inserted into a metal sheet 10 and a longitudinal section through the corresponding tools 12, 13. In this case, the press-in connecting element 1 is preferably pressed into a pre-punching 11, inserted in the metal sheet 10, with the corresponding tools 12, 13 and anchored therein. The component or workpiece can, by way of example, be a component or workpiece produced from a steel sheet by punching and bending. Preferably, the material hardness of the press-in connecting element 1 is greater than the material hardness of the metal sheet 10.

The shaft section 3 comprises, by way of example, a joining section 3.1, which directly adjoins the head section 2 along the longitudinal axis LA, which joining section can be adapted with respect to its extent along the longitudinal axis LA depending on the material strength of the metal sheet 10, into which the press-in connecting element 1 according to the invention is intended to be anchored, and/or the respective application. The shaft section 3 further comprises a press-in section 3.2 on its free end opposite the head section 2, which press-in section is preferably formed by an annular press-in collar revolving concentrically around the longitudinal axis LA. If there is no pre-punching 11 in the metal sheet 10, the press-in section 3.2 can also form an annular press-in edge, by means of which a slug is punched out, in order to enable joining of the subsequent joining section 3.1.

The joining section 3.1 has a lateral surface having a knurl RA, in particular a knurl RA having a plurality of grooves running parallel to the longitudinal axis LA, which is designated RAA knurl. As a result, a serrated profile extending circumferential around the longitudinal axis LA is produced on the lateral surface of the joining section 3.1, wherein a groove is enclosed in each case between two consecutive serrations. The knurl RA has a knurl depth T.

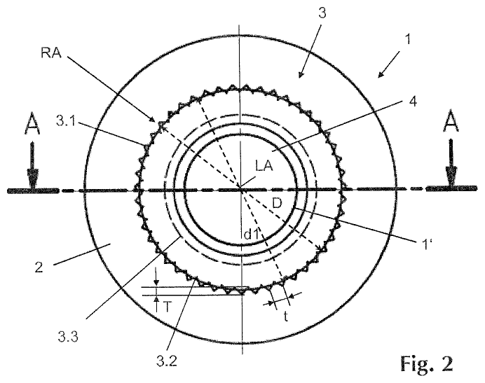

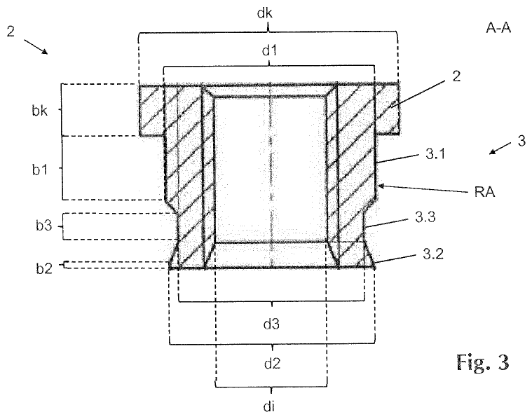

The knurl RA illustrated or indicated in FIGS. 1 to 5 is, by way of example, formed as an RAA knurl having a spacing t of 0.8 mm and a profile angle of 90°. It is evident that RAA knurls with different spacings t standardized according to DIN 82, by way of example 0.5 mm, 0.6 mm, 1.0 mm, 1.2 mm or 1.6 mm can also be used. Alternative profile angles are also possible.

Before the knurl RA is formed in the lateral surface of the joining section 3.1, the latter has an initial diameter D, which, depending on the selected spacing t, produces a nominal diameter or first diameter d1 of the knurled joining section 3.1. The nominal diameter or first diameter d1 in this case designates the diameter of a virtual circumference around the longitudinal axis LA, on which the outer tips of the knurl RA or serrations of the serrated profile come to rest. In other words: the first diameter d1 designates the outer diameter of the knurled joining section 3.1.

The knurl depth T corresponds to the difference of the radius of the virtual circumference around the longitudinal axis LA, on which the outer tips of the knurl RA or of the serrations of the serrated profile come to rest, and the radius of the further virtual circumference around the longitudinal axis LA, on which the inner tips of the knurl RA or of the serrations of the serrated profile come to rest.

In the case of an RAA knurl, by way of example, the following relationship exists between the initial diameter D of the still unknurled joining section 3.1, the nominal diameter or first diameter d1 and the spacing t:

D=d1−0.5*t

The knurl RA is in this respect preferably produced by turning. Alternatively, the knurl RA can be produced by cold working.

According to the invention, the knurled joining section 3.1 comprises the first diameter d1 and the press-in section 3.2 a second diameter d2, wherein the second diameter d2 is smaller than the first diameter d1. In this context, the second diameter d2 corresponds approximately to the initial diameter D of the joining section 3.1 before the knurl RA is formed in the lateral surface thereof, in particular in the case of a knurl RA produced by turning, or the second diameter d2 corresponds approximately to the first diameter d1 minus half of the knurl depth T, in particular in the case of a knurl RA produced by means of cold working. The second diameter d2 is thus reduced by half of the knurl depth R in comparison to the first diameter d1. The inventors have discovered that in the case of a respective dimensioning of the first diameter and second diameter d1, d2 of the knurled joining section 3.1 and of the press-in section 3.2, there is no material displacement when joining the joining section 3.1 into the metal sheet 10, as advantageously the joining region is already correspondingly prepared over the press-in section 3.2.

According to the invention, the following relationship thus exists between the first diameter and second diameter d1, d2 and the spacing t of the knurl RA formed as an RAA knurl:

d2=d1−0.5*t

In the case of an RAA knurl having a spacing t of 0.8 mm and a profile angle of 90°, the following relationship thus emerges, by way of example, between the first diameter d1 of the knurled joining section 3.1 and the second diameter d2 of the press-in section 3.2:

d2=d1−0.5*0.8 mm=d1−0.4 mm

or

d1=d2+0.4 mm

The first diameter d1 of the knurled joining section 3.1 is thus 0.4 mm larger than the second diameter d2, i.e. the difference of the first diameter and second diameter d1, d2 is selected depending on the spacing t of the knurl RA. This applies in particular to an RAA knurl produced by turning.

Alternatively, the following relationship exists between the first diameter and second diameter d1, d2 and the knurl depth T of the knurl RA:

d2=d1−0.5*T

In the case of a knurl depth T of 0.8 mm, the following relationship thus emerges, by way of example, between the first diameter d1 of the knurled joining section 3.1 and the second diameter d2 of the press-in section 3.2:

d2=d1−0.5*0.8 mm=d1−0.4 mm

The first diameter d1 of the knurled joining section 3.1 is in both cases 0.4 mm larger than the second diameter d2, i.e. the difference of the first diameter and second diameter d1, d2 is selected depending on the spacing t of the knurl RA or on the knurl depth T. This applies in particular to an RAA knurl produced by turning or cold working.

In one preferred embodiment, the head section 2 is likewise formed by a circular-cylindrical section, which has a head diameter dk and a head width bk respectively relative to the longitudinal axis LA. The preferably circular-cylindrical cavity 4 further has an inner diameter di, which is selected depending on the application, in particular depending on the size of the internal thread to be provided.

An annular undercut section 3.3 is arranged between the joining section 3.1 and the press-in section 3.2, which undercut section forms a recess which is groove-shaped and/or annular and extends concentrically toward the longitudinal axis LA, in which recess the material of the metal sheet 10 is plastically deformed in the joining region when pressing the press-in connecting element 1 inserted into the metal sheet 10. The annular undercut section 3.3 can have different cross-sectional shapes, by way of example form an undercut which is triangular or trapezoidal in the cross section. The annular undercut section 3.3 has thus a reduced cross-section in comparison to the joining section 3.1 and the press-in section 3.2 and thus jumps back radially in the direction of the longitudinal axis LA.

As a result of filling of the annular undercut section 3.3 with material of the metal sheet 10, the press-in connecting element 1 is additionally anchored in the metal sheet 10 alongside the knurl RA of the joining section 3.1 and is secured in particular against twisting.

The knurled joining section 3.1 is formed by a knurled, circular-cylindrical section which directly adjoins the head section 2 along the longitudinal axis LA, which section has a first width b1 relative to the extension along the longitudinal axis LA. The press-in section 3.2 is provided on the opposite free end of the shaft section 3, the second diameter b2 of said press-in section being relative to that outer circumferential surface or circumferential edge of the press-in section 3.2, which has the greatest radial distance to the longitudinal axis LA. This press-in section 3.2 is, by way of example, formed by an annular press-in collar, the greatest outer diameter of which forms the second diameter d2. Preferably, the end face of the press-in section 3.2 of the shaft section 3 forms a flat annular surface, which is concentric with respect to the longitudinal axis LA.

Finally, the annular undercut section 3.3. comprises a third diameter d3, preferably in the region of the circumferential surface with the lowest radial distance to the longitudinal axis LA. The third diameter d3 of the annular undercut section 3.3 is smaller than the first diameter and second diameter d1, d2. The difference between the second diameter and third diameter d2, d3 is preferably selected in the region of between 0.25 times and one times the spacing t of the knurl RA of the knurled joining section 3.1 formed as an RAA knurl.

In the present exemplary embodiment in accordance with FIGS. 1 to 3, the annular undercut section 3.3 is formed by a circular-cylindrical section extending circumferentially and concentrically around the longitudinal axis LA and having a third width b3, which section merges into the joining section 3.1 or the press-in section 3.2, widening the cross section, via in each case a transition section extending obliquely to the longitudinal axis LA.

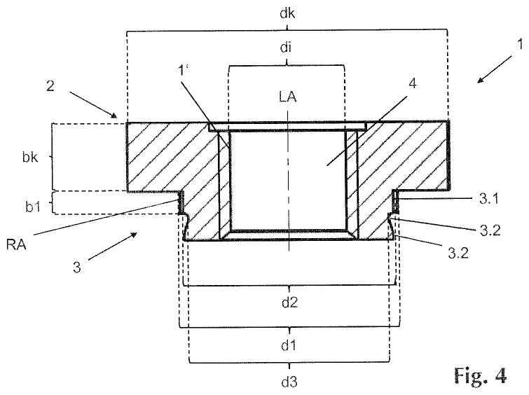

In a further alternative embodiment in accordance with FIGS. 4 and 5, the annular undercut section 3.3 comprises an arcuate cross-sectional profile, such that the third width b3 is reduced substantially to an apex line having the smallest radial distance to the longitudinal axis LA.

In further embodiment variants (not illustrated), the annular undercut section 3.3 can comprise a triangular cross-sectional profile, wherein this annular undercut section 3.3 opens outward in the form of a gap or the receiving space formed thereby tapers in the direction of the longitudinal axis LA.

FIG. 5 shows, by way of example, in a schematic side view the tools, in particular press tools, provided for inserting the press-in connecting element 1 into the metal sheet 10 or into a pre-punching 11 provided by way of example, by joining and pressing. The diameter of the pre-punching 11 is preferably selected to be marginally smaller than or the same as the second diameter d2 of the press-in section 3.2 or the outer diameter D of the joining section 3.1 before the knurl RA is formed. Alternatively, a corresponding slug can firstly be punched out of the metal sheet by means of the press-in section 3.2 and the tools 12, 13, which enables subsequent joining of the joining section 3.1 in the tool.

In order to attach the press-in connecting element 1 to the metal sheet 10, the press-in connecting element 1 is inserted with deformation of the material of the metal sheet 10 around, by way of example, the previously punched-out joining opening or pre-punching 11, in such a manner that the material flows radially into the grooves, running parallel to the longitudinal axis LA, of the knurl RA, nevertheless preventing an axial displacement of the material in the joining direction, i.e. along the longitudinal axis LA. After joining, the head section 2 with its lower side facing towards the joining section 3.1 bears against the upper side 10a of the metal sheet, wherein the remaining shaft section 3 is preferably completely received in the pre-punching 11 and, by way of example, flush or approximately flush with the lower side 10b of the metal sheet 10. The shaft section 3 can also project with its free end, and with the press-in section 3.2 over the lower side 10b of the metal sheet 10.

Subsequently, in a press or a press tool with the head section 2 supported against a support 12, using a die 13 having an annular embossing collar 14, plastic deformation takes place of the material of the metal sheet 10 into the recess, which is groove-shaped and/or annular by way of example and extends concentrically around the longitudinal axis LA and is formed by the annular undercut section 3.3. In the case of a stationary die 13, the support 12 is formed by way of example by a pressing punch or pressing plunger.

In order to anchor the press-in connecting element 1 in the joining opening or pre-punching 11, the die 13, which encloses or fully receives the press-in section 3.2 or press-in collar when pressing with its embossing collar 14, almost exclusively exerts force on the material of the metal sheet 10 in such a manner that primarily a flow of the material of the metal sheet 10 is brought about without deforming the press-in connecting element 1 for the anchoring or pressing of the press-in connecting element 1 in the metal sheet 10. The transmission of force takes place in this context exclusively over the embossing collar 14 in the direction of the longitudinal axis LA.

FIG. 5 thus shows, by way of example, a prefabricated assembly comprising a press-in connecting element 1 according to the invention and a metal sheet 10, wherein the press-in connecting element 1 is inserted into the metal sheet 10 indicated by way of example, by joining and pressing. It is understood that the metal sheet 10 indicated can also be part of a component or workpiece produced therefrom, without hereby departing from the inventive concept.

With the method described previously, anchoring of the press-in connecting element 1 with high press-out force or high press-out strength and with a high torque, i.e. with high resistance to twisting, is achieved. After the anchoring of the press-in connecting element 1 in the metal sheet 10 has been completed, the annular undercut section 3.3 bears in its entire profile, in particular also in the region of the transitions to the joining section 3.1 and/or press-in section 3.2 with a high pressing or clamping force against the peripheral region, which surrounds the joining opening or pre-punching 11, of the metal sheet 10.

The invention has been described above using exemplary embodiments. It is understood, that numerous changes and modifications are possible, without hereby departing from the inventive concept upon which the invention is based.

### REFERENCE LIST

1 press-in connecting element
1′ inner wall
2 head section
3 shaft section
3.1 joining section
3.2 press-in section
3.3 undercut section
4 cavity
10 metal sheet
10a upper side
10b lower side
11 pre-punching
12 support
13 die
14 embossing collar
b1 first width
b2 second width
b3 third width
bk head width
d1 first diameter
d2 second diameter
d3 third diameter
dk head diameter
di inner diameter
LA longitudinal axis
RA knurl
t spacing
T knurl depth

1. A press-in connecting element for inserting into a permanently deformable flat metal material, component or workpiece produced therefrom, by joining and pressing, comprising a head section and a shaft section, the shaft section adjoins the head section along a longitudinal axis (LA) and is set back relative to the head section, the shaft section comprises at least a joining section, which directly adjoins the head section and a press-in section, which adjoins the joining section along the longitudinal axis (LA), wherein the joining section has a lateral surface having a knurl (RA) which has a knurl depth (T), wherein the joining section has a first diameter (d1) and the press-in section has a second diameter (d2) and the second diameter (d2) is smaller than the first diameter (d1), wherein the second diameter (d2) corresponds approximately to an initial diameter (D) of the joining section before the knurl (RA) is formed in the lateral surface or approximately to the first diameter (d1) minus half of the knurl depth (T).

2. The press-in connecting element as claimed in claim 1, wherein the knurl (RA) is formed as an RAA knurl having a plurality of grooves running parallel to the longitudinal axis (LA).

3. The press-in connecting element as claimed in claim 2, wherein the knurl (RA) formed as an RAA knurl has a spacing (t) and a profile angle.

4. The press-in connecting element as claimed in claim 3, wherein a difference between the first diameter (d1) and the second diameter (d2) is dependent on the spacing (t) of the knurl (RA).

5. The press-in connecting element as claimed in claim 1, wherein the following relationship exists between the first diameter (d1) and the second diameter (d2) and the spacing (t):
d1−0.5*t=d2

6. The press-in connecting element as claimed in claim 1, wherein the first diameter (d1) corresponds to a diameter of a virtual circumference around the longitudinal axis (LA), on which outer tips of the knurl (RA) come to test.

7. The press-in connecting element as claimed in claim 6, wherein the knurl depth (T) corresponds to a difference of a radius of the virtual circumference around the longitudinal axis (LA), on which the outer tips of the knurl (RA) come to rest, and a radius of a further virtual circumference around the longitudinal axis (LA), on which the inner tips of the knurl (RA) come to rest.

8. The press-in connecting element as claimed in claim 2, wherein an annular undercut section is formed between the joining section and the press-in section, the annular undercut section has a third diameter (d3), which is smaller than the second diameter (d2).

9. The press-in connecting element as claimed in claim 8, wherein a difference between the second diameter (d2) and the third diameter (d3) is between 0.25 times and one times the spacing (t) of the knurl (RA) formed as an RAA knurl.

10. The press-in connecting element as claimed in claim 1, wherein the press in section is formed by an annular press-in collar.

11. A prefabricated assembly comprising the press-in connecting element as claimed in claim 1 and a permanently deformable flat metal material or a component or workpiece produced therefrom, wherein the press-in connecting element is inserted into the permanently deformable flat metal material or a component or workpiece produced therefrom, by joining and pressing.

12. A method for anchoring the press-in connecting element as claimed in claim 1 in a permanently deformable flat metal material, in particular a metal sheet or a component or workpiece produced therefrom by joining and pressing, wherein the press-in connecting element the head section and the shaft section, which adjoins the head section along the longitudinal axis (LA) and which is set back relative to the head section, said shaft section comprising at least the joining section, which directly adjoins the head section, with the lateral surface having the knurl (RA) and the press-in section, which adjoins the joining section along the longitudinal axis (LA), comprising the step of:
inserting the press-in connecting element without material displacement of the flat metal sheet along the longitudinal axis (LA) or in the joining direction, into a permanently deformable flat metal sheet, into a joining opening or pre-punching provided therein when joining the press-in connecting element into the permanently deformable flat metal sheet.

13. The method as claimed in claim 12, further comprising the step of:
displacing the metal sheet surrounding the press-in connecting element exclusively radially with respect to the longitudinal axis (LA) or joining direction when joining the press-in connecting element into the flat metal sheet.

14. The method as claimed in claim 13, further comprising the step of:
pressing the press-in connecting element into an annular undercut section provided between the joining section and the press-in section after being joined into the permanently deformable flat metal sheet in such a manner that the material of the flat metal sheet surrounding the press-in connecting element is plastically deformed and is displaced into the annular undercut section provided between the joining section and the press in section.

15. The method as claimed in 14, further comprising the step of:
anchoring the press-in connecting element in the flat metal sheet during pressing, by a die interacting with a support and having an embossing collar receiving the press-in section in such a manner that a flow of the material of the flat metal sheet is brought about without deforming the press-in connecting element.
